(19) United States
(12) Patent Application Publication
(10) Pub. No.: US 2014/0272207 A1
(43) Pub. Date: Sep. 18, 2014

(54) Adsorbent For Use As A Window Desiccant

(71) Applicant: Micropore, Inc., Elkton, MD (US)

(72) Inventors: Douglas B. McKenna, Avondale, PA (US); Vince Suddard, Newark, DE (US)

(73) Assignee: MICROPORE, INC., Elkton, MD (US)

(21) Appl. No.: 14/211,537

(22) Filed: Mar. 14, 2014

Related U.S. Application Data
(60) Provisional application No. 61/790,196, filed on Mar. 15, 2013.

(51) Int. Cl. E06B 3/663; B01J 20/26

(52) U.S. Cl. CPC E06B 3/663; B01J 20/261
USPC 428/34; 252/194; 428/304.4; 428/40.2; 428/343; 428/68; 428/220

(57) ABSTRACT

The present application provides an adsorbent strip that prevents window fogging, the strip including no more than 25 weight percent of polymer binder; and at least 75 weight percent of adsorbent particles. Also provided is a window spacer comprising the adsorbent strip and a partial window assembly, including a first pane of glass, a second pane of glass; and a window spacer comprising the adsorbent strip.

This application claims the priority of U.S. Provisional Appl. No. 61/790,196, filed Mar. 15, 2013, which is incorporated herein by reference in its entirety.

### TECHNICAL FIELD

This description relates to high density adsorbents and particularly to a window spacer including such high density adsorbent strips.

### BACKGROUND

Double pane windows having two panels of glass configured parallel to each other can benefit from the use of an adsorbent to reduce (e.g., prevent) fogging of the window. Double pane windows are prone to accumulation of chemical “fog” on the interior surfaces of the glass panels. Organic and inorganic materials in structures within the interior of a window assembly having two panels of glass can off-gas and cause fogging. Fogging can also be caused by moisture from the atmosphere that passes through a seal and/or spacer and then condenses on the interior of the window assembly. Windows may go through large temperature swings that contribute to the expansion and contraction of gasses within the interior of the window assembly. Desiccants are often used around the perimeter of the window to absorb moisture and reduce (e.g., prevent) fogging.

Adsorbents granules or beads may be used as an adsorbent between glass panes in the window assembly, however, loose beads are messy and difficult to work with and have a limited packing density. For example, a mono-modal sized bead will have a 37% volume of air between the granules or beads.

Commonly available molecular sieve materials comprise adsorbent particles bound with clay binders. The adsorbent particles themselves may have a specific density of about 1.53 g/cc, however, the space between the particles and the space between the granules results in a and a bulk density of about 0.64 g/cc. Additionally, granular molecular sieves beads use binders, such as clay, which further reduces typically reduces the volumetric density of the adsorbent in the composite of molecular sieves and binders to 0.54 g/cc or less. The combination of relatively low volumetric density of the composite and along with the ease of use of adsorbent beads described above makes the use of adsorbent particles bound with clay binders less than ideal.

Adsorbent particles may be combined with a polymer and extruded directly into the final shape of the window spacer, making the installation of the absorbent particles much easier and improves its ease of use. However, this technique results in low adsorbent volumetric density. The adsorbent density can be increased somewhat, but at the expense of the spacer being brittle and prone to breaking during installation, along with reduced flexibility and adsorbent particle retention.

There exists a need for an adsorbent that can be used in a window spacer that remains flexible for ease of use and limits adsorbent dusting, while maintaining high adsorbent volumetric loading capacity.

### SUMMARY

The invention is directed to a high capacity elongated preformed adsorbent having a high adsorbent concentration that in a preferred embodiment is configured for double pane window adsorbent applications. The elongated preformed adsorbent has a high concentration of adsorbent particles and low particulate shedding, is easy to handle and incorporate into window manufacturing processes.

Accordingly, in some embodiments, the present application provides an adsorbent strip or elongated preformed adsorbent suitable for preventing window fogging, comprising:

i. no more than 25 weight percent of polymer binder; and

ii. at least 75 weight percent of adsorbent particles.

In some embodiments, the adsorbent strip has an aspect ratio of length to maximum cross-section dimension of at least 5.

Further, the present application provides a window spacer, comprising:
an adsorbent strip, comprising:
i. no more than 25 weight percent of polymer binder; and
ii. at least 75 weight percent of adsorbent particles;
the adsorbent strip having an aspect ratio of length to maximum cross-section dimension of at least 5, wherein the adsorbent strip prevents window fogging.

Any of the adsorbent strips (or elongated preformed adsorbent) described herein may be used in the window spacers.

In some embodiments, the elongated preformed adsorbent or adsorbent strip comprises adsorbent particles interconnected by polymer binder and is, in an exemplary embodiment, produced through a thermally induced phase process as described in U.S. Pat. No. 5,964,221, which is incorporated herein by reference in its entirety. The elongated preformed adsorbent or adsorbent strip, as described herein, may comprise any suitable weight percent of adsorbent particles, including, but not limited to, at least 80% by weight of adsorbent particles, at least 85% by weight of adsorbent particles, at least 90% by weight of adsorbent particles, at least 95% by weight of adsorbent particles, or at least 98% by weight of adsorbent particles, and any range between and including the weight percent values provided. Likewise, the adsorbent, as described herein, may have an adsorbent particulate volume concentration that is at least 80%, at least 85%, at least 90%, at least 95%, and any range between and including the volume concentrations provided. While the adsorbent may have similar specific adsorbent density as granular or beaded adsorbents, there is no additional air space as is the case between granules or beads where there is 37% or more void space between beads. As such, without this extra void space between beads, the density of the adsorbent in use in a window can be higher than that of granular adsorbents while also being easier to use in a manufacturing environment. Furthermore, the elongated preformed adsorbent or adsorbent strip may have higher particle retention than adsorbent and binder compositions where the binder is not oriented. It is believed that the thermally induced phase process nucleates polymer on substantially every particle and therefore more effectively binds and retains particles. In addition, in some embodiments the polymer binder is oriented providing improved mechanical strength, such as tensile strength in the orientation of polymer binder orientation.

The adsorbent particles may be any suitable size including, but not limited to, no more than about 100 um, no more than about 50 um, no more than about 25 um, no more than about 10 um, no more than about 5 um, and any range between and including the size dimensions provided. The adsorbent particles may include any type or combination of suitable materials, including inorganic compounds, zeolites, activated carbon, molecular sieves, and the like. In some embodiments, the adsorbent particles adsorb water. In some embodiments, the adsorbent particles are molecular sieves. In some embodiments, the adsorbent particles are molecular sieves and the polymer binder is ultra high molecular weight polyethylene. In some embodiments, the adsorbent particles consist essentially of one type of adsorbent particle of material. In other embodiments, a plurality of adsorbent particles may be incorporated into the adsorbent including a bi-modal, tri-modal or multi-modal combination of particles having a different particle sizes. In some embodiments, the adsorbent particles comprise a first plurality of adsorbent particles having a first mean particle size and a second plurality of adsorbent particles having a second mean particle size, wherein the first mean particle size and second mean particle size are different.

Likewise the adsorbent material may have any suitable density including, but not limited to, no more than about 2 g/cc, no more than about 1.5 g/cc, no more than about 1 g/cc, no more than about 0.75 g/cc, no more than about 0.5 g/cc, no more than about 0.3 g/cc, no more than about 0.2 g/cc, and any range between and including the densities provided. The density of the adsorbent material will be affected by the adsorbent particle type, concentration and porosity of the adsorbent material.

The adsorbent can be made with a very high concentration of adsorbent particles with very little binder, thereby providing a volumetric density of adsorbent of about 0.75 g/cc or higher in the case of 13x molecular sieve. In contrast, clay binder/adsorbent compositions are limited to a volumetric density of about 054 g/cc or less. Volumetric density, as used herein, is defined as the weight of adsorbent particles divided by the volume and does not include the polymer or clay or any binder in the calculation.

The adsorbent of the elongated preformed adsorbent or adsorbent strip, described herein, may be made by the process described in U.S. 2005/0160812 to McKenna et al, and/or U.S. 2011/0206572, each of which is incorporated by reference herein in their entirety. In a preferred embodiment, the adsorbent is created by mixing adsorbent powder with oil and a polymer at an elevated temperature, and then creating a microporous structure by way of thermally induced phase separation of the polymer. The process oil is then extracted, leaving the adsorbent powder held together by the polymer.

The polymer binder may be any suitable type or combination of materials including, but not limited to, thermoplastics, soluble polymers, ultra high molecular weight polymers, ultra high molecular weight polyethylene, polytetrafluoroethylene, urethane, elastomer, fluoroelastomer and the like. In some embodiments, the polymer binder is polyethylene. In some embodiments, the polymer binder is ultra-high molecular weight polyethylene.

In some embodiments, the adsorbent strip comprises no more than 20% by weight of polymer binder and greater than 80% by weight of adsorbent particles, no more than 15% by weight of polymer binder and greater than 85% by weight of adsorbent particles, no more than 10% by weight of polymer binder and greater than 90% by weight of adsorbent particles, no more than 5% by weight of polymer binder and greater than 95% by weight of adsorbent particles, or no more than 2% by weight of polymer binder and greater than 98% by weight of adsorbent particles. In some embodiments, the adsorbent particles are interconnected by the polymer binder to form a self-supporting porous adsorbent. In some embodiments, from about 20% to about 100% of the adsorbent particles are interconnected by the polymer binder.

In some embodiments, the window spacer further comprises a foam contacting the top surface of the adsorbent strip. In some embodiments, the window spacer further comprises a non-permeable layer surrounding the bottom surface of the strip, a first surface of the spacer along the length of the strip, and a second surface opposite said first surface of the strip, optionally having an adhesive layer on outside of the non-permeable layer with an optional release paper. In some embodiments, the foam and non-permeable layer are bonded to the adsorbent strip to make the window spacer using any suitable adhesive. In some embodiments, the non-permeable layer comprises a metal foil layer, polymer film layer, or a composite system of layers (e.g., polymer/metal foil or polymer/polymer laminates).

In some embodiments, the window spacer is flexible. Accordingly, in one embodiment, the window spacer is wound to form a roll. In some embodiments, the adsorbent strip is from about 0.01 to 0.05 inches, 0.020 to about 0.040 inches, or 0.020 to about 0.04 inches thick.

In another embodiment, the present application provides a partial window assembly which utilizes the window spacers described herein, comprising:

a first pane of glass;

a second pane of glass; and

the window spacer as described in any of the embodiments, the window spacer having a first surface along the length of the strip and a second surface opposite said first surface;

wherein the window spacer is secured between the first and the second panes of glass parallel to an edge of the panes, wherein the first surface of the window spacer is adhered to the first pane of glass and the second surface of the window spacer is adhered to the second pane of glass;

wherein the first pane and the second pane are separated by a distance equal to or larger than the maximum cross-section dimension.

The partial window assembly represents a stage in the process of assembling a window using the described window spacers and adsorbent strips. In some embodiments, the window spacer further comprises a foam contacting the top surface of the adsorbent strip. In some embodiments, the window spacer further comprises a non-permeable layer surrounding to the bottom surface of the adsorbent strip, the first surface of the window spacer and the second surface of the window. In some embodiments, the non-permeable layer comprises a metal foil layer, polymer film layer, or a composite system of layers.

In some embodiments, the first pane and the second pane are separated by a distance equal to the maximum cross-section dimension

In some embodiments, the partial window assembly further comprises a sealant sealing the first pane and second panes of glass along the bottom edge of the window spacer and between the panes of glass, thereby preventing air incursion past the window spacer. In some embodiments, the sealant comprises urethane.

In some embodiments, the partial window assembly further comprises a sash securing the first pane of glass and the second pane of glass, the sash configured to be inserted into a window frame. In some embodiments, a thickness of the first and second panes of glass is between 1/16 inch to ¼ inch each.

The present application further provides a method of producing a partial window assembly, comprising securing one or more window spacers as described in any of the embodiments between a first pane of glass and a second pane of glass parallel to an edge of the panes, the window spacer having a first surface along the length of the strip and a second surface opposite said first surface; comprising:

adhering the first surface of the window spacer to the first pane of glass; and

adhering the second surface of the window spacer to the second pane of glass;

wherein the first pane and the second pane are separated by a distance equal to or larger than the maximum cross-section dimension.

In some embodiment, the method further comprises sealing the first pane and second panes of glass along the bottom edge of the window spacer and between the panes of glass, thereby preventing air incursion past the window spacer.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A shows a schematic of the adsorbent material as described herein.

FIG. 1B shows a schematic of the adsorbent material comprising oriented polymer binder as described herein.

FIG. 1C shows a schematic of the adsorbent material comprising aligned oriented polymer binder as described herein.

FIG. 2A shows a cross-sectional schematic of the adsorbent material comprising an integral adsorbent retention layer as described herein.

FIG. 2B shows a surface schematic of the adsorbent material comprising an integral adsorbent retention layer described herein.

FIG. 3A shows a surface schematic of the adsorbent material comprising reinforcement fibers as described herein.

FIG. 3B shows a cross-section schematic of the adsorbent material comprising reinforcement fibers as described herein.

FIG. 4 shows a cross-section schematic of a partial window assembly.

FIG. 5 shows a cross-section schematic of a partial window assembly.

FIG. 6 shows a cross-section schematic of a partial window assembly.

FIG. 7 shows a cross-section schematic of a partial window assembly.

FIG. 8 shows a cross-section schematic of a partial window assembly.

FIG. 9 shows a cross-section schematic of a partial window assembly.

FIG. 10 shows a process schematic for making the adsorbent material described herein.

Like reference symbols in the various drawings indicate like elements.

### DETAILED DESCRIPTION

Certain exemplary embodiments are described herein and illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, and improvements are within the scope of the present invention. The embodiments depicted in the Figures are embodiments and are not limiting. It is intended that the embodiments described herein can be combined in any suitable combination as if written in multiply dependent claims.

In some embodiments, the adsorbent material 10 comprises adsorbent particles 12, 12′ interconnected with polymer binder 14, 14′ as shown in FIG. 1A. Some of the polymer binder may contact both adsorbent surfaces as shown in 14′ and may not be oriented as described herein. The adsorbent material 10 comprises polymer binder 14 that interconnects the adsorbent particles 12 by contacting the adsorbent particles and extending to another adsorbent particle 12′, as shown in FIG. 1A. The polymer binder 14 may be branched wherein a first portion of polymer may be connected with a second portion of polymer between two or more particles, as show in FIG. 1B. Any suitable percentage of the adsorbent particles may be interconnected with the polymer as described herein. A higher concentration of adsorbent particles may provide improved adsorption performance. In one embodiment, the adsorbent material is made by a thermally induced phase separation process, and comprises a uniquely high percentage of adsorbent particles by mass or volume relative to polymer content, and interconnected with said polymer.

In some embodiments, substantially all of the adsorbent particles are interconnected by polymer binder as shown in FIGS. 1A, and 1B. In addition, as shown in FIG. 1B, some of the polymer binder is oriented polymer binder 42, wherein it is elongated between and interconnecting adsorbent particles, and has an aspect ratio of at least 2:1 where the length of the oriented polymer is shown as PBL in FIG. 1B. Furthermore, as shown in the cross sectional schematic of the adsorbent material in FIG. 1C, the oriented polymer binder is aligned, or oriented substantially in the same direction, with a majority of the oriented polymer binder being elongated in substantially the same direction. Substantially the same direction, as used herein, means within a 30 degree inclusive angle of the average oriented polymer binder direction. The arrow over the adsorbent material in FIG. 1C represents the process direction of the material. This aligned orientation of the polymer binder may be imparted during the processing of the material, such as during extrusion, roll to roll transfer between process steps, during calendaring, during integral channel formation, or during a separate process step where the adsorbent material may be elongated. Additionally, the polymer binder may be oriented in the same plane as the machine direction, but perpendicular to the machine direction.

Any number and type of adsorbent particles may be used. The adsorbent particles may have any suitable shape and size. One or more types of adsorbent particles may be incorporated into the adsorbent material in any suitable ratio, or weight percentage. The adsorbent particles may be any suitable size including, but not limited to, no more than about 200 um, no more than about 100 um, no more than about 50 um, no more than about 25 um, no more than about 10 um, no more than about 5 um, and any range between and including the size dimensions provided. The adsorbent particles may comprises any type or combination of suitable materials, including inorganic compounds, zeolites, activated carbon, lithium hydroxide, calcium hydroxide, molecular sieves, 13X and the like. In some embodiments, the adsorbent particles consist essentially of one type of adsorbent material.

The polymer binder may be any suitable type or combination of materials including, but not limited to, thermoplastics, soluble polymers, ultra high molecular weight polymers, ultra high molecular weight polyethylene, polytetrafluoroethylene, urethane, elastomer, fluoroelastomer and the like. Oriented polymer binder may significantly increase the strength of the adsorbent material. Any suitable percentage of the polymer binder may be oriented as defined herein, including, but not limited to, at least about 10%, at least about 40%, at least about 50%, at least about 60%, at least about 70%, and any range between and including the values provided. In one embodiment, the polymer binder is substantially oriented, wherein at least 70% of the polymer is oriented as shown in FIG. 1B. The oriented polymer may have any suitable aspect ratio, including but not limited to, greater than about 2:1, greater than about 3:1, greater than about 5:1, greater than about 10:1, greater than about 25:1, greater than about 40:1, greater than about 50:1, greater than 100:1 and any range between and including the aspect ratios provided. In addition, the oriented polymer may have any suitable diameter or maximum cross length dimension including, but not limited to, no more than about 2 um, no more than about 1 um, no more than about 0.5 um, and any range between and including the dimensions provided.

The polymer content of the adsorbent material may be any suitable percentage by weight including, but not limited to, no more than about 10%, no more than about 8%, no more than about 5%, no more than about 4%, no more than about 3%, no more than about 2%, no more than about 1%, no more than about 0.6%, and any range between and including any of the provided percentages by weight. Low concentration of polymer means a higher concentration of adsorbent particles which may increase adsorption capabilities including rate and quantity.

In one embodiment, the polymer binder is substantially oriented, wherein at least 70% of the polymer is oriented. The oriented polymer may have any suitable aspect ratio, including but not limited to, greater than about 2:1, greater than about 3:1, greater than about 5:1, greater than about 10:1, greater than about 25:1, greater than about 40:1, greater than about 50:1, and any range between and including the aspect ratios provided. In addition, the oriented polymer may have any suitable diameter or maximum cross length dimension including, but not limited to, no more than about 2 um, no more than about 1 um, no more than about 0.5 um, and any range between and including the dimensions provided. Oriented polymer binder may be substantially aligned in the same direction, wherein the long axis of the oriented polymer binder are all substantially aligned. For example, in one embodiment the adsorbent material comprises oriented polymer binder that is substantially aligned in the processing direction of the material. Oriented polymer binder in an adsorbent may provide for increased strength, such as tensile strength in the direction of polymer orientation. Increased tensile strength may provide for reduce deformation of an elongated preformed adsorbent when subjected to compression or tension in an application.

The adsorbent material 10 is porous, allowing for the diffusion of gas into the structure whereby specific gas molecules may be adsorbed by the adsorbent particles. The adsorbent may have any suitable porosity including, but not limited to, more than about 5%, more than about 10%, more than about 20%, more than about 30%, more than about 50%, more than about 60%, more than about 70%, more than about 80%, more than about 90%, more than about 95%, and any range between and including the percentages provided. The adsorbent material may be non-permeable, having substantially no bulk air flow through the material. For example, in one embodiment, the adsorbent material is a sheet having a Gurley Densometer, Model 4340 automatic Gurley Densometer time of more than 100 seconds, as defined herein, or more than 25 seconds, or more than 50 seconds, or more than 200 seconds, or more than 300 seconds, or more than 400 seconds. In some embodiments, the adsorbent sheet may have a reduced Gurley time of less than 100 seconds (e.g., in some embodiments, the sheet may comprise reinforcement fibers which may open up the spacing between adsorbent particles.

The adsorbent sheet may further comprise an integral adsorbent retention layer 50 on at least one surface, and may be on both surfaces as depicted in FIGS. 2A and 2B. In one embodiment, the integral adsorbent retention layer is not within the surface of the integral channels described herein. An integral adsorbent retention layer is a thin layer of material on the surface of an adsorbent sheet. As shown in FIG. 2A and FIG. 2B, the integral adsorbent retention layer 50 is very thin and discontinuous having openings 52 between portion of the integral adsorbent retention layer. The openings 52 may be continuous as depicted in FIG. 2B, and/or discrete, wherein they are defined by an outer boundary of the integral adsorbent retention layer, such as a hole in the integral adsorbent retention layer. The integral adsorbent retention layer may comprise smeared polymer binder material and adsorbent material. In one embodiment, the integral adsorbent retention layer consists essentially of polymer binder and may be smeared or comprise a thin film layer of polymer binder. The integral adsorbent retention layer may occlude any suitable percentage of the surface of the adsorbent material including but not limited to no more than about 90%, no more than about 80%, no more than about 70%, no more than about 60%, no more than about 50%, no more than about 40%, and any range between and including any of the percentages provided. The integral adsorbent retention layer may comprise openings 52 having any suitable nominal pore size including but not limited to no more than about 100 um, no more than about 50 um, no more than about 25 um, no more than about 10 um, no more than about 5 um, no more than about 3 um, no more than about 2 um, no more than about 1 um, and any range between and including any of the pore sizes provided. The integral adsorbent retention layer may have any suitable thickness including but not limited to, no more than about 5 um, no more than about 3 um, no more than about 2 um, no more than about 1 um, no more than about 0.75 um, no more than about 0.5 um, and any range between and including the thickness values provided.

In some embodiments, the adsorbent material may further comprise reinforcement fibers 60 that may be incorporated into the adsorbent material as depicted in FIGS. 3A and 3B. The reinforcement fibers may be incorporated into any portion of the adsorbent material including into the integral adsorbent retention layer. As depicted in the surface schematic of FIG. 3A, the reinforcement fibers may be disposed within the adsorbent material, and intertwine with the polymer binder and adsorbent particles. The reinforcement fibers may be concentrated within a plane of a sheet of adsorbent material, such as on one surface. As shown in FIG. 3B, the cross-section schematic depicts reinforcement fibers extending through the thickness of the adsorbent material. The reinforcement fibers may have a concentration gradient with the adsorbent material, such as being concentrated on the surfaces and or within the center of the thickness of the adsorbent material. Reinforcement fibers may increase the mechanical strength and durability of the adsorbent material. For example, the compressive strength may be improved with reinforcing fibers, even when increasing the distance between powder particles, thereby reducing adsorbent material density, and reducing macro diffusion resistance between adsorbent particles (by increasing the void space between particles.

In some embodiments, any suitable amount of reinforcement fibers may be included into the adsorbent material, and may comprise any suitable weight percentage of the adsorbent material including, but not limited to, no more than about 50%, no more than about 40%, no more than about 30%, no more than about 20%, no more than about 10%, no more than about 5%, no more than about 2%, no more than about 1%, and any range between and including the weight percentages provided. The reinforcement fibers may have any suitable length and cross-length dimension, such as diameter or width. The length of the reinforcement fiber may be any suitable length including, but not limited to, no more than about 0.01 mm no more than about 0.05 mm, no more than about 0.10 mm, no more than about 0.25 mm, no more than about 0.5 mm, no more than about 0.75 mm, no more than about 1 mm, no more than about 2 mm, no more than about 4 mm, no more than about 8 mm, and any range between and including the lengths provided. The width or maximum cross-length dimension may be any suitable dimension including, but not limited to, no more than about 0.1 um, no more than about 1 um no more than about 5 um, no more than about 20 um, no more than about 50 um, no more than about 100 um, no more than about 500 um, and any range between and including the lengths provided. The reinforcement fibers may be added at any suitable time in the process of making the adsorbent material, including during the mixing process, during the extrusion process, during the calendaring process, and the like.

FIG. 4 shows an adsorbent strip 10. The substantially rectangular-shaped adsorbent strip 10 has a top surface 50 that is substantially parallel with a bottom surface 51. The adsorbent strip 10 has a first side surface 52 that is substantially parallel to a second side surface 53 on an opposite side of the strip. The adsorbent strip 10 has a length L and a maximum cross-section CL. CL may be between ¼ inch to ¾ inch (e.g. ½ inch, ¾ inch) An aspect ratio may be defined as the ratio of L to CL, and may be greater than 5, greater than 10, greater than 20, greater than 100, and in some cases greater than 1000. The top surface 50 may be exposed to the interior space between two panes of glass. The bottom surface 51 may be in contact with a non-permeable film or a sealant. The side surfaces 53 and 54 are each adhered to a length along an edge of a pane of glass.

The adsorbent strip 10 includes at least 75 weight percent of adsorbent particles and no more than 25 weight percent of polymer binder, at least 80% by weight of adsorbent particles, at least 85% by weight of adsorbent particles, at least 90% by weight of adsorbent particles, at least 95% by weight of adsorbent particles, at least 98% by weight of adsorbent particles. The adsorbent strip 10 includes no more than 20% by weight of polymer binder and greater than 80% by weight of adsorbent particles, no more than 15% by weight of polymer binder and greater than 85% by weight of adsorbent particles, no more than 10% by weight of polymer binder and greater than 90% by weight of adsorbent particles, no more than 5% by weight of polymer binder and greater than 95% by weight of adsorbent particles, no more than 2% by weight of polymer binder and greater than 98% by weight of adsorbent particles.

The polymer binder may include polyethylene and/or ultra-high molecular weight polyethylene. The adsorbent particles may include one or more of inorganic compounds, zeolites, activated carbon, and molecular sieves. The adsorbent strip 10 may include adsorbent particles that are interconnected by the polymer binder to form a self-supporting porous adsorbent in which from about 20% to about 100% of the adsorbent particles are interconnected by the polymer binder. A window spacer formed using the adsorbent strip 10 may be flexible and may be wound on a roll. In some embodiments, the absorbent strip is from about 0.020 to about 0.040 inches thick.

In some embodiments, the adsorbent strip 10 forms part of a window spacer. The adsorbent may be formed using a thermally induced phase separation process. The adsorbent particles can include a first group of adsorbent particles having a first mean particle size and a second group of adsorbent particles having a second, different mean particle size.

FIG. 5 shows a portion of a window assembly 100. The window assembly 100 includes a first pane of glass 80 and a second pane of glass 82. An interior space 60 is defined between the two panes of glass. The top surface 50 of the absorbent is exposed to the interior space 60. The first side surface 52 of the adsorbent strip 10 is secured to an edge of the first pane of glass 80 along its length (i.e., into the plane of the drawing) by an adhesive 55. Similarly, the second side surface 53 of the adsorbent strip 10 is secured to an edge of the second pane of glass 82 along its length by the adhesive 55. These elements form a window spacer and the mechanical stability of the window spacer is maintained by the adhesive 55. The adhesive 55 may be urethane adhesive and may be applied using a glue gun. A sealant 54 below the adsorbent strip 10 can seal the first pane and second panes of glass along 80 and 82 along a bottom edge of the window spacer and between the panes of glass, thereby preventing air incursion past the window spacer. A sash 90 (cross section shown) secures the window spacer and the sealant. Together these elements are inserted into window frame 92 (cross section shown). The two panes of glass are separated by a distance greater than the maximum cross-section of the adsorbent strip 10. Each of the panes of glass 80 and 82 may be between 1/16 inch to ¼ inch thick.

FIG. 6 shows a portion of a window assembly 110. The assembly 110 is similar to assembly 100 except that instead of a rectangular adsorbent strip 10, an adsorbent strip 101 having a trapezoidal cross-section is used. Here, a first side surface 152 is not parallel to a second side surface 153, and the area of the top surface 50 is smaller than the area of the bottom surface 51.

FIG. 7 shows a portion of a window assembly 120. The assembly 120 is similar to assembly 100 except for an additional non-permeable layer 56 that surrounds the first side surface 52, bottom surface 51 and the second side surface 53 of the adsorbent strip 10. The non-permeable layer 56 may be provided to improve mechanical and dimensional stability of the window assembly. The non-permeable film 56 may optionally have an adhesive layers on both its interior and exterior surfaces. These adhesive layers may be initially covered with an optional release paper. The non-permeable layer 56 can include a metal (e.g., aluminum) foil layer, a polymer (e.g., plastic) film layer, or a composite system of layers including having metal and/or polymer layers. In the composite system of layers, an adhesive may be present at the interfaces between different layers. In some embodiments, the non-permeable layer forms a barrier against moisture and/or air.

FIG. 8 shows a portion of a window assembly 130. The assembly 130 is similar to assembly 120 except for an additional covering 98 over the top surface 51 of the adsorbent strip. The covering 98 includes openings 99 to allow for gas access to the adsorbent strip 10. The covering and the non-permeable layer 56 may be configured around any suitable portion of the adsorbent strip, such as completely around the cross-sectional perimeter, as shown, or around a portion of the perimeter. The coverings and the non-permeable film may include breaks to allow the window spacer to bend to accommodate installation of the window spacer into a window corner.

FIG. 9 shows a portion of a window assembly 140. The assembly 140 is similar to the assembly 120 except for an additional foam layer 44 covering the top surface 50 of the adsorbent strip 10. The foam layer 44 may include silicone foam having porous channels through which moisture from the interior space 60 (shown in FIG. 4) pass through to reach the top surface 50 of the adsorbent strip 10.

FIG. 10 shows a process schematic for making the adsorbent material described herein which can be made through any suitable set of process steps. In some embodiments, the adsorbent material is made by a thermally induced phase separation process. The method can involve i) dissolving a polymer in a solvent at elevated temperatures to form a polymer solution. Subsequently, adding adsorbent particles to the polymer solution and mixing the components to form an adsorbent slurry. Thereafter, extruding the adsorbent slurry to form an extrudate or sheet. Cooling the extrudate to cause thermally induced phase separation, forming integral channels in the extrudate, and extracting the polymer solvent from said extrudate to form an adsorbent sheet having integral channels. The solvent may be heated to any suitable temperature to cause the selected polymer to dissolve.

A number of embodiments of the invention have been described. Nevertheless, it will be understood that various modifications may be made without departing from the spirit and scope of the invention. Accordingly, other embodiments are within the scope of the following claims.

What is claimed is:

1. A window spacer, comprising:
an adsorbent strip, comprising:
i. no more than 25 weight percent of polymer binder; and
ii. at least 75 weight percent of adsorbent particles;
the adsorbent strip having an aspect ratio of length to maximum cross-section dimension of at least 5, wherein the adsorbent strip prevents window fogging.

2. The window spacer of claim 1, wherein the adsorbent strip is formed using thermally induced phase separation.

3. The window spacer of claim 2, wherein the adsorbent strip comprises no more than 10% by weight of polymer binder and greater than 90% by weight of adsorbent particles.

4. The window spacer of claim 2, wherein the adsorbent strip comprises no more than 5% by weight of polymer binder and greater than 95% by weight of adsorbent particles.

5. The window spacer of claim 2, wherein the adsorbent strip comprises no more than 2% by weight of polymer binder and greater than 98% by weight of adsorbent particles.

6. The window spacer of claim 2, wherein the polymer binder is ultra-high molecular weight polyethylene.

7. The window spacer of claim 2, wherein the adsorbent particles are molecular sieves.

8. The window spacer of claim 2, wherein the adsorbent particles are interconnected by the polymer binder to form a self-supporting porous adsorbent.

9. The window spacer of claim 2, wherein the window spacer further comprises a foam contacting the top surface of the adsorbent strip.

10. The window spacer of claim 2, wherein the window spacer further comprises a non-permeable layer surrounding the bottom surface of the strip, a first surface of the spacer along the length of the strip, and a second surface opposite said first surface of the strip, optionally having an adhesive layer on outside of the non-permeable layer with an optional release paper.

11. The window spacer of claim 10, wherein the non-permeable layer comprises a metal foil layer, polymer film layer, or a composite system of layers.

12. The window spacer of claim 2, wherein the window spacer is flexible.

13. The window spacer of claim 2, wherein the maximum cross-section of the adsorbent strip is from about ¼ inch to about ¾ inches.

14. The window spacer of claim 2, wherein the adsorbent strip is from about 0.020 to about 0.040 inches thick.

15. A partial window assembly, comprising:
a first pane of glass;
a second pane of glass; and
the window spacer of claim 1, the window spacer having a first surface along the length of the strip and a second surface opposite said first surface;
wherein the window spacer is secured between the first and the second panes of glass parallel to an edge of the panes, wherein the first surface of the window spacer is adhered to the first pane of glass and the second surface of the window spacer is adhered to the second pane of glass;
wherein the first pane and the second pane are separated by a distance equal to or larger than the maximum cross-section dimension.

16. The partial window assembly of claim 15, wherein the window spacer further comprises a foam contacting the top surface of the adsorbent strip.

17. The partial window assembly of claim 15, wherein the window spacer further comprises a non-permeable layer surrounding to the bottom surface of the adsorbent strip, the first surface of the window spacer and the second surface of the window.

18. The partial window assembly of claim 17, wherein the non-permeable layer comprises a metal foil layer, polymer film layer, or a composite system of layers.

19. The partial window assembly of claim 18, further comprising a sealant sealing the first pane and second panes of glass along the bottom edge of the window spacer and between the panes of glass, thereby preventing air incursion past the window spacer.

20. The partial window assembly of claim 19, further comprising a sash securing the first pane of glass and the second pane of glass, the sash configured to be inserted into a window frame.
